(19) United States
(12) Patent Application Publication
(10) Pub. No.: US 2014/0164137 A1
(43) Pub. Date: Jun. 12, 2014

(54) PRICING SYSTEM FOR ON-LINE ADVERTISEMENTS

(71) Applicant: Facebook, Inc., Menlo Park, CA (US)

(72) Inventor: Nipun Mathur, Menlo Park, CA (US)

(73) Assignee: Facebook, Inc., Menlo Park, C (unknown)

(21) Appl. No.: 13/708,621

(22) Filed: Dec. 7, 2012

(51) Int. Cl. G06Q 30/02

(52) U.S. Cl. CPC G06Q 30/0275
USPC 705/14.66

(57) ABSTRACT

Based on a request for an advertisement, a social networking system retrieves information about a user and identifies candidate advertisement (“ad”) objects having targeting criteria satisfied by the information about the user. The social networking system selects a candidate ad object based on associated bid prices and sends a description of the selected candidate ad object to an external system including a bid price for the candidate ad object. Based on bid prices of advertisements stored by the external system and bid price from the description, the external system determines an external clearing price for the candidate ad object and communicates the external clearing price to the social networking system. The social networking system determines a fee for serving an advertisement from the selected candidate ad object based on an internal clearing price for the selected candidate ad object and the external clearing price.

### BACKGROUND

The present disclosure relates to advertisement pricing, and in particular to pricing advertisements based on the results of auctions internal to a social networking system and external to the social networking system.

Social networking systems often obtain significant revenue from providing advertisements to their users. Targeting advertisements based on user-specific information stored by a social networking system allows the social networking system provide advertisers with greater advertisement revenue than broad-based ads because users typically perceive targeted advertisements as more relevant. By serving more relevant ads, advertisers increase the conversion rate of viewers of the ads to purchasers of the proposed goods or services, benefitting the advertiser, and allowing the social networking system to request increased compensation from the advertiser for targeting advertisements.

Conventional models for pricing advertisements are generally built around auctions treating both targeted and non-targeted advertisements the same. Accordingly, current pricing models do not allow advertisement pricing to account for use of information for targeting advertisement. This may limit the revenue for entities, such as social networking system, providing the information used for advertisement targeting.

### SUMMARY

Embodiments of the present disclosure enable a social networking system to price and provide an advertisement to a requesting device for presentation to a user. The social networking system receives user identification information from the requesting device and retrieves a user profile associated with a user of the requesting device. Based on the user profile, the social networking system retrieves a plurality of candidate advertisements having one or more targeting criteria satisfied by the user profile. Each of the candidate advertisements is associated with a bid price, and the social networking system adjusts each of the bid prices to include a fee for using information from the user profile maintained by the social networking system. Based on the adjusted bid prices, the social networking system selects a candidate advertisement. For example, the social networking system performs an auction process using the adjusted bid prices to select the candidate advertisement. The social networking system sends description information of the selected candidate advertisement, including the adjusted bid price associated with the selected candidate targeted advertisement, to an external system, which selects an advertisement from additional advertisements based on bid prices associated with the additional advertisements and the adjusted bid price of the selected candidate targeted advertisement.

The social networking system receives the external clearing price associated with the selected candidate targeted advertisement from the external system. For example, the description information includes an external auction clearing price associated with the selected candidate targeted advertisement if the selected candidate targeted advertisement wins an auction performed by the external system. The social networking system adjusts the external clearing price to include a transaction fee for using the external system. Based on the internal clearing price and the adjusted external clearing price of the selected candidate targeted advertisement, the social networking system determines a fee for serving the selected candidate advertisement to the user. For example, the social networking system selects the greater of the internal clearing price and the adjusted external clearing price as the fee for the selected candidate targeted advertisement. The advertiser associated with the selected advertisement is charged the fee and the selected candidate targeted advertisement is sent to the requesting device for presentation.

In some embodiments, the social networking system modifies the selected candidate targeted advertisement to include social context information before it is communicated to the requesting device. The social context information may identify actions performed by other users of the social networking system connected to the user. For example, an action by a user connected to the user being presented the advertisement and involving content associated with the selected advertisement is identified and embedded in the selected advertisement.

### BRIEF DESCRIPTION OF THE DRAWINGS

FIG. 1 is an interaction diagram of an example process for pricing and presenting advertisements, in accordance with an embodiment.

FIG. 2 illustrates a block diagram of a system environment for pricing and presenting advertisements to users of a social network, in accordance with an embodiment.

FIG. 3 is an example block diagram of an architecture of a social networking system, in accordance with an embodiment.

FIG. 4 illustrates a flowchart of one embodiment of a process for pricing and selecting an advertisement for a social networking system user, in accordance with an embodiment.

The figures depict various embodiments of the present disclosure for purposes of illustration only. One skilled in the art will readily recognize from the following discussion that alternative embodiments of the structures and methods illustrated herein may be employed without departing from the principles of the embodiments described herein.

### DETAILED DESCRIPTION

### Overview

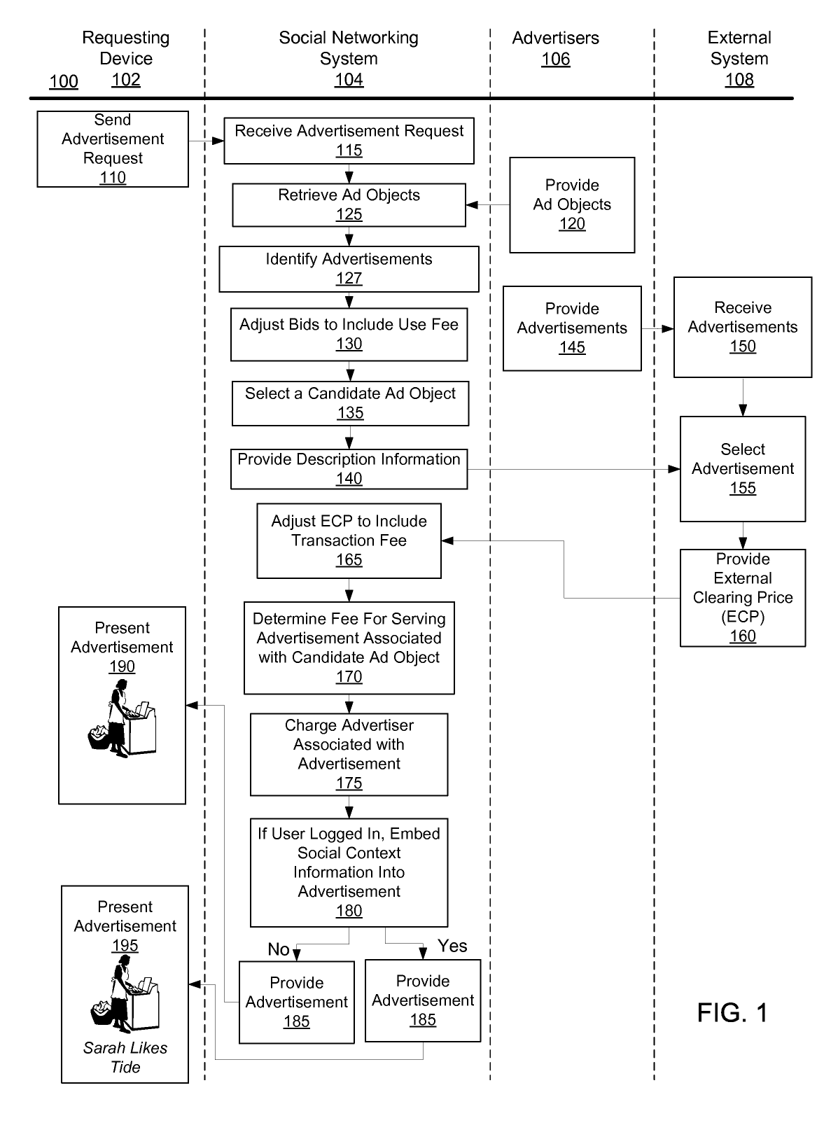

FIG. 1 is an interaction diagram of an example process 100 for pricing and presenting targeted advertisements. The process 100 shown by FIG. 1 includes a requesting device 102 communicates with a social networking system 104 to retrieve advertisements for presentation to a user of the requesting device 102. The requesting device 102 sends an advertisement request 110 to the social networking system 104 that includes user identification (“ID”) information that specifies information identifying a user of the social networking system 104. The user ID information may be associated with a social networking application included on the requesting device 102. For example, user ID information includes a user identifier uniquely associating the user with a user profile within the social networking system 104, a login and password, or other data uniquely identifying a social networking system user.

In some embodiments, the advertisement request includes one or more request parameters. Request parameters specify conditions for limiting advertisements provided to the requesting device 102. For example, a request parameter specifies the social networking system 104 select advertisements that have not been previously provided to the requesting device 102 by the social networking system 104, specifies the social networking system 104 select advertisements not provided to the requesting device 102 within a specified time period, or any other suitable criteria.

When the advertisement request is received 115, the social networking system 104 retrieves 125 candidate advertisement (“ad”) objects based on data in the advertising request, such as the user ID information and any additional request parameters. In some embodiments, the social networking system 104 extracts a user identifier from the user ID information to identify the user profile associated with the user. In other embodiments, the social networking system 104 matches the user ID information to the user profile associated with the user using, for example, a look up table. Each candidate ad objects include an advertisement, targeting criteria associated with the advertisement, and a bid price. An advertisement generally includes any communication intended to cause the recipient of the communication to take some action concerning a product or service. For example, an advertisement includes an offer for a deal. To increase the likelihood that a user presented with a an advertisement interacts with the advertisement, the candidate ad objects, targeting criteria may be associated with an advertisement identifying one or more characteristics of users eligible to be presented with the advertisement. Advertisers 106 may associate targeting criteria with an advertisement so that users with characteristics specified by the targeting criteria are presented with the advertisement. Additionally, an advertiser 106 may compensate the social networking system 104 to compare targeting criteria in ad objects with user profile information maintained by the social networking system 104. For example, an advertiser 106 pays a premium price to the social networking system 104 if one or more advertisements associated with the advertiser 106 are presented to social networking system users satisfying one or more targeting criteria in an ad object. For example, UNILEVER®, TIDE®, and CLOROX® may associate targeting criteria identifying users that are identified as mothers with advertisements having respective bid prices of $0.50, $1.00, and $0.90. In contrast, non-targeted advertisements from the same advertisers may have respective bid prices of $0.20, $0.15, and $0.30. The increased bid prices for the advertisements associated with targeting criteria reflect the increased likelihood of a user satisfying the targeting criteria interacting with the advertisements.

The social networking system 104 may retrieve 125 the ad objects from, for example, an advertisement store. In some embodiments, an advertiser 106 provides 120 targeting criteria, advertisements, and bid prices stored as an ad objects to the social networking system 104. Alternatively, an advertiser 106 may indirectly provide information for ad objects via an ad network or an ad exchange. In some embodiments, the social networking system 104 may actively request ad objects from advertisers 106, which provide 120 information for ad objects to the social networking system 104 based on the request. An advertiser 106 provides an advertisement and a bid price without targeting criteria to the social networking system 106, which analyzes the advertisement content to identify targeting criteria stored with the advertisement and bid price as an ad object. For example, if no targeting criteria are provided, the social networking system 104 analyzes the advertisement content to infer targeting criteria using a fuzzy matching algorithm based on the types of interactions performed by users, user characteristics, and/or types of connections between users in the group as characteristics. Additionally, in some embodiments, the social networking system 104 may send the advertiser 106 some information associated with the user subject to privacy settings specified by the user. This information may assist the advertiser 106 in selecting which ad objects are provided 120. A privacy setting of the user determines how particular information associated with the user can be shared. The social networking system 104 may communicate information about the user to the advertiser 106 using any suitable manner, such as via an iframe or a social plug-in executing on a website external to the social networking system 140, communicating the information to the advertiser 106 based on a relationship between the advertiser 106 and the social networking system 140, or through any other suitable manner.

The social networking system 104 identifies 127 candidate ad objects. For example, information from a user profile associated with the user of the requesting device is compared to targeting criteria of candidate ad objects, and candidate ad objects having one or more targeting criteria matched by the user profile information are identified 127. Social networking system 104, as further described below, maintains user profiles, edges, and content objects to provide information about its users. These user profiles, edges, and content objects may be analyzed to identify users matching one or more targeting criteria of an advertisement. For example, groups of users having a common characteristic satisfying one or more targeting criteria are identified and associated with ad objects including the targeting criteria. For example, the social networking system 104 associates one or more ad objects including targeting criteria identifying a characteristic of “mother” with users identifying themselves as mothers in their associated user profiles. Hence, the social networking system 104 may generate a group of users having one or more characteristics specified by targeting criteria and generate a group of users identifying user identifiers of the users having the satisfied characteristics, allowing more efficient identification of targeting criteria satisfied by a user based on user identifier. Alternatively, targeting criteria matched by a user are associated with the user, allowing targeting criteria satisfied by the user to be identified from a user identifier.

The social networking system 104 extracts the user identifier from the received user ID information and determines one or more targeting criteria satisfied by the corresponding user. Based on the targeting criteria (e.g., being a mother), the social networking system 104 identifies 127 one or more candidate ad objects having associated with targeting criteria satisfied by the identified user. Request parameters, if any, are applied to filter the candidate ad objects. For example, if a request parameter specifies presentation of an advertisement that has not been previously provided to requesting device 102, social networking system 104 removes ad objects including advertisements previously provided to the requesting device 102 from the candidate ad objects.

The social networking system 104 adjusts 130 the bid price associated with each candidate ad object to include a use fee, which is a fee the social networking system 104 charges an advertiser 106 for using data associated with users by the social networking system 104. In one embodiment, the use fee is charged to an advertiser 106 if an advertisement from the advertiser 106 is presented to a user. For example, the bid prices of each candidate ad object is be reduced by the fee amount (e.g., 10%). Thus, if candidate ad objects have bid prices of $0.50, $1.00, and $0.90, their adjusted bid prices would be $0.45, $0.90, and $0.81, respectively. In some embodiments, the bid prices of the candidate ad objects may not be adjusted 103, or may be adjusted in conjunction with a different step. For example, the use fee may be added after selecting an advertisement for presentation.

Based on the adjusted bid prices of the candidate ad objects, the social networking system 104 selects 135 a candidate ad object. For example, the social networking system 104 performs an auction internal to the social networking system 104 to select 135 a candidate ad object based on the adjusted bid prices of the candidate ad objects. In some embodiments, an expected value for each candidate ad object is computed. For example, the expected value of a candidate ad object is the product of the candidate ad object's adjusted bid price by a probability of the candidate ad object being accessed. To estimate the probability that a user will click on an advertisement from a candidate ad object, the social networking system 104 may use the user's affinities for targeting criteria associated with the candidate ad object, the user's affinity for content associated with the advertisement in the candidate ad object, or with other data associated with the candidate ad object. The social networking system 104 ranks the candidate ad objects and selects a candidate ad object associated with the highest expected value. In some embodiments, the social networking system 104 uses the adjusted bid price of a candidate ad object as the candidate ad object's expected value.

The social networking system 104 determines an internal clearing price for the selected candidate ad object. For example, the internal clearing price is set as the adjusted bid price of the candidate ad object having the second highest adjusted bid price. For example, if the selected candidate ad object has a bid price of $0.90, and the candidate ad object having the second highest bid price of $0.81, the internal clearing price for the selected candidate object is set as $0.81. Alternatively, the internal clearing price for the selected candidate object is set as the second highest adjusted bid price incremented by a specified value (e.g., 1 cent).

Description information associated with the selected candidate ad object is provided 140 from the social networking system 104 to an external system 108 (e.g., an ad exchange). The description information may include the advertisement from the selected ad object, a bid price from the selected ad object, the internal clearing price, the adjusted bid price of the selected ad object, a link to the advertisement from the selected ad object, or any other suitable information. In the example shown by FIG. 1, the adjusted bid price of the selected ad object is provided 140 to the external system 108, although other values may be provided 140, such as the internal clearing price, or another value.

The external system 108 retrieves one or more additional advertisements provided 145 by one or more advertisers 106 and/or received 150 from additional sources. The additional advertisements may not have associated targeting criteria or may be from advertisers 106 not using information from the social networking system 104 to identify users to be presented with the additional advertisements. Advertisers 106 may directly provide 145 the additional advertisements to the external system 108 or may indirectly provide 145 the additional advertisements using an ad network or an ad exchange. The external system 108 may actively request non-targeted ad objects from advertisers 106, which provide 145 additional advertisements to the external system 108 based on the request.

The external system 108 selects 155 an advertisement using the additional advertisements and the description of the selected candidate ad object. For example, the external system 108 conducts 155 an auction using the description information and one or more additional advertisements. In one embodiment, the external system 108 selects 155 an advertisement from the additional advertisements having the highest bid price or having a highest expected value, as described above. For example, the external system 108 performs an auction including additional advertisements having bid prices of $0.25, $0.10, and $0.50, and including the candidate ad object having a bid price of $0.90 (e.g., the adjusted bid price of the candidate ad object). If the external system 108 selects 155 the selected candidate ad object, an external clearing price for the candidate ad object is determined by the external system 108. In the preceding example, the external system 108 selects 155 the advertisement as the candidate ad object, because it has the highest bid price of $0.90. If the external system 108 includes an alternative advertisement having a higher bid price than the adjusted bid price of the candidate ad object, the external system 108 selects the alternative additional advertisement and presents it to the user. In an embodiment, the external system 108 may notify the social networking system 104 that an alternative advertisement was served to the user.

The external system 108 associates an external clearing price with the selected candidate ad object, if it is selected 155 by the external system 108. In some embodiments, the external clearing price is set as the second highest bid price of the additional advertisements used by the external system 108 along with the description of the selected candidate ad object to select 155 an advertisement. For example, if the selected candidate ad object has an adjusted bid price of $0.90 and additional advertisement has the second highest bid price of $0.50, the external clearing price for the selected candidate ad object may be set as $0.50. In other embodiments, the external clearing price is set as the second highest bid price incremented by a specified amount (e.g., 1 cent higher).

The external clearing price of the selected candidate ad object is provided 160 by the external system 108 to the social networking system 104, if the external system selects 155 the selected candidate ad object. The social networking system 104 adjusts 165 the external clearing price to include a transaction fee, which is assessed by the external system 108 for selecting 155 an advertisement using its stored information. For example, the transaction fee may be 10% of the external clearing price; if the external clearing price is, $0.50, the adjusted external clearing price is increased by the 10% transaction fee to $0.55.

The social networking system 104 determines 170 a fee for serving the advertisement associated with the candidate ad object to the user using the internal clearing price and the adjusted external clearing price. If an advertisement maintained by the external system 108 has a higher bid price than the adjusted internal bid price of the selected candidate ad object, the candidate ad object is not served by the social networking system. Rather, the external system 108 serves the advertisement having the higher bid price than the adjusted internal bid price of the selected candidate ad object. As the social networking system 104 does not serve an advertisement, the social networking system 104 determines 170 the fee is zero.

However, if the adjusted external clearing price is less than the internal clearing price, the social networking system 104 determines 170 the fee is the internal clearing price. If the adjusted external clearing price is greater than the internal clearing price, the social networking system 104 determines 170 the fee is the adjusted external clearing price. As described above, selected candidate ad object has an internal clearing price of $0.81 and an external adjusted clearing price of $0.55. Thus, the social networking system 104 determines 170 that the fee for serving the candidate advertisement to the user is the larger value of $0.81.

After determining the fee, the social networking system 104 charges 175 the fee to the advertiser associated with the selected candidate ad object. The amount of compensation received by the social networking system 104 for serving the advertisement depends on the fee determination. For example, if an advertisement is served by the external system 108, the social networking system 104 does not receive any compensation, as it does not serve an advertisement. However, if the internal clearing price is determined 170 as the fee, the social networking system 104 receives compensation of the difference in the internal clearing price and the external clearing price. If the external clearing price, adjusted to include the transaction fee, is determined 170 as the fee, the social networking system 104 receives the transaction fee as compensation. In the preceding example where a fee of $0.81 is charged to an advertiser for presenting the advertisement associated with the selected candidate ad object, the social networking system pays the $0.50 external clearing price to the external system 108, resulting in a net of $0.81-$0.50, or $0.31, to the social networking system 108. In some embodiments, the social networking system 104 may charge the advertiser only the net fee to the social networking system 104 (e.g., $0.31), and the advertiser is responsible for paying the external clearing price (e.g., $0.50) to the external system 108.

The selected advertisement is provided 185 to the requesting device 102 by the social networking system 104 and is presented 190 to the user by the requesting device 102. In some embodiments, the social networking system 104 may also present social context information along with the selected advertisement. To present social context information, the social networking system 104 determines whether the user is logged into the social networking system 104 (e.g., via a social networking application on the requesting device 102, a browser operating on the requesting device 102, etc). If the user is logged onto the social networking system 104, the social networking system identifies social context associated with the user and embeds 180 social context information associated with the user into the selected advertisement. Social context information identifies actions between the users or users connected to the user with the advertisement, with content associated with the advertisement, with an advertiser associated with the advertisement, or other suitable objects. For example, if user X is connected to users Sarah and Zack, and user Sarah has expressed a preference for a page in the social networking system 104 associated with a product in the selected advertisement, the selected advertisement is modified to include social context information that “Sarah likes Tide” when provided 185 to user X. The advertisement and embedded social context, if any, may be presented 190 by the requesting device 102 in any suitable manner. For example, the requesting device 102 displays the selected advertisement to the user, plays audio associated with the selected advertisement for the user, or otherwise presents 190 the selected advertisement to the user.

### System Architecture

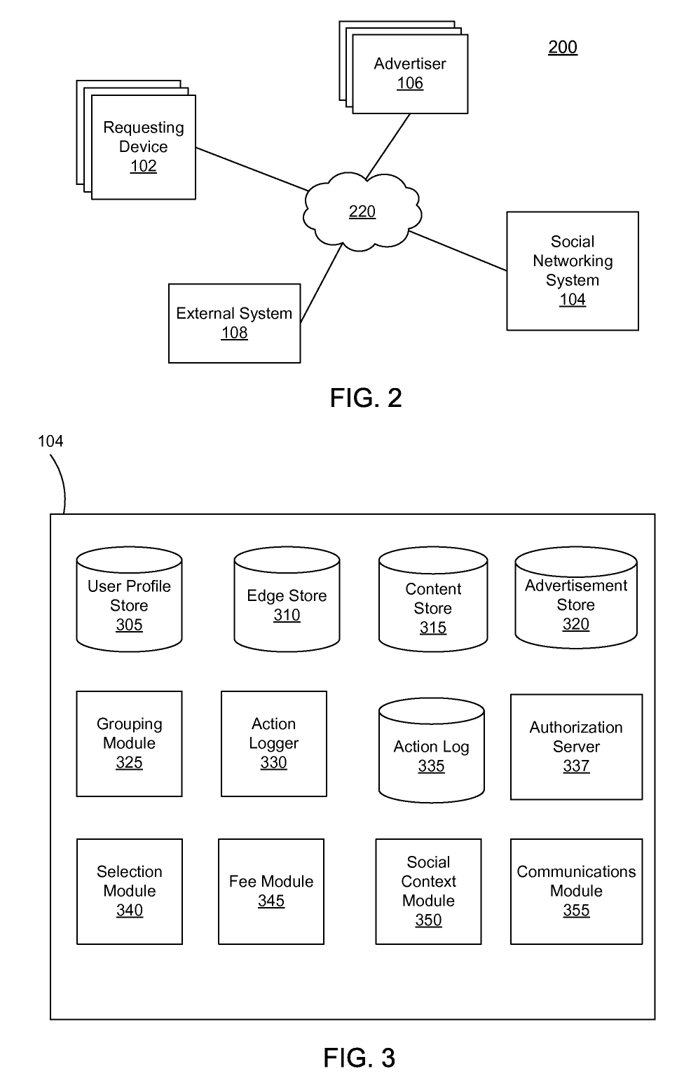

FIG. 2 illustrates a block diagram of a system environment 200 for pricing and presenting advertisements to users of a social networking system 104. The system environment 200 includes one or more requesting devices 102, the social networking system 104, one or more advertisers 106, an external system 108, and a network 220. In various embodiments, the system environment 200 may be organized in an alternative topology or configuration, and include different and/or additional modules.

The advertisers 106 provide ad objects or data for generating ad objects to entities in system environment 200. As described above, the ad objects include advertisements for presentation to a user of the social networking system 104. The external system 108 is a system that facilitates bidding, buying, selling, or some combination thereof, of ad objects from advertisers 106 to systems delivering advertisements associated with the ad objects to users. For example, the external system 108 may be an ad exchange or an ad network.

The requesting devices 102 comprise one or more computing devices capable of processing data as well as transmitting and/or receiving data via the network 220. Examples of a requesting device 102 include a mobile device and a desktop computer. A mobile device may be, for example, a mobile telephone, a smart phone, a tablet computer, a laptop computer, or some other portable device that may display advertisements. A requesting device 102 may execute a social networking application. The social networking application allows a social networking system user to exchange data with the social networking system 104 via a requesting device 102 and the network 220. Alternatively, a social networking system user accesses the social networking system 104 via a browser executing by the requesting device 102. User ID information for each user of the requesting device 102 that previously accessed the social networking system 104 may be stored by the requesting device 102.

The requesting devices 102 are configured to communicate with the social networking system 104 or other devices via the network 220. In one embodiment, the network 220 uses standard communications technologies and/or protocols. Thus, the network 220 may include wired and/or wireless communication channels using technologies such as Ethernet, 802.11 family of standards, worldwide interoperability for microwave access (WiMAX), 3G, 4G, CDMA, digital subscriber line (DSL), etc. Examples of networking protocols used by the network 220 include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 220 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 3 is an example block diagram of an architecture of the social networking system 104. In the embodiment shown by FIG. 3, the social networking system 104 includes a user profile store 305, an edge store 310, a content store 315, an advertisement store 320, a grouping module 325, an action logger 330, an action log 335, an authorization server 337, a selection module 340, a fee module 345, a social context module 350, and a communications module 355. In other embodiments, the social networking system 104 may include additional, fewer, or different modules for various applications. Conventional components such as network interfaces, security functions, load balancers, failover servers, management and network operations consoles, and the like are not shown so as to not obscure the details of the system architecture.

User account information and other related information for users are stored as user profiles in user profile store 305. For example, each user of the social networking system 104 is associated with a user identifier that is unique to the user. The user identifier is stored in a user profile maintained by the user profile store 305. Additionally, the user profile store 305 may store logins and passwords, or other data uniquely identifying users. Some of this information may be used by the user profile store 305 to match user ID information with the associated user profile using, for example, a lookup table. Information stored in a user profile describes a social networking system user. Examples of information stored in a user profile include: biographic, demographic, and other types of descriptive information, such as work experience, educational history, gender, hobbies or preferences, location, and the like. User profile information may also store other information provided by the user, for example, images or videos. In certain embodiments, images of users may be tagged with information identifying users of the social networking system 104 displayed in an image. The user profile store 305 also maintains references to the actions stored in an action log 335 and performed on objects in the content store 315. A user profile may also include information indicating whether a user corresponding to the user profile is currently logged into social networking system 104.

The edge store 310 stores the information describing connections between users and other objects on the social networking system 104 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 104, such as expressing interest in a page on the social networking system 104, sharing a link with other users of the social networking system 104, and commenting on posts made by other users of the social networking system 104.

The edge store 310 also includes information about edges, such as affinity scores for objects, interests, and other users. Affinity scores may be computed by the social networking system 104 over time to approximate a user's affinity for an object, interest, and other users in the social networking system 104 based on the actions performed by the user. Computation of affinity is further described in U.S. patent application Ser. No. 12/978,265, filed on Dec. 23, 2010, which is hereby incorporated by reference in its entirety. Multiple interactions between a user and a specific object may be stored in one edge in the edge store 310, in one embodiment. For example, a user that plays multiple songs from Miles Davis' album, “Kind of Blue,” may have multiple edges between the user and different songs, but a single edge between the user and an object for Miles Davis.

The content store 315 stores content items associated with a user profile, such as images, videos, and audio files. Content items from the content store 315 may be displayed when a user profile is viewed or when other content associated with the user profile is viewed. For example, displayed content items may show images or video associated with a user profile or show text describing a user's status. Additionally, other content items may facilitate user engagement by encouraging a user to expand his connections to other users, to invite new users to the system, or to increase interaction with the social networking system 104 by displaying content related to users, objects, activities, or functionalities of the social networking system. Examples of social networking content items include suggested connections or suggestions to perform other actions, media provided to, or maintained by, the social networking system 104 (e.g., pictures or videos), status messages or links posted by users to the social networking system 104, events, groups, pages (e.g., representing an organization or commercial entity), and any other content provided by or accessible via the social networking system 104.

In one embodiment, advertisement objects (“ad objects”) are stored in the advertisement store 320; however, in other embodiments, ad objects may be stored in the content store 315. Ad objects may be received from one or more of advertisers 106 and/or from the external system 108. An ad object includes an advertisement and an associated bid price and may also include targeting criteria specifying one or more characteristics of a user eligible to be presented the advertisement. The bid price specifies an amount of compensation an advertiser 106 will provide the social networking system 104 for presenting the advertisement to a user, for receiving a user interaction with the advertisement, or based on any other suitable criteria. The bid price may be used to determine an expected value to the social networking system 104 for presenting an advertisement to a user. For example, the bid price specifies a monetary amount that the social networking system 104 receives from the advertiser if the advertisement is displayed and the expected value is determined by multiplying the bid price by a probability of the advertisement being accessed.

In one embodiment, the social networking system 104 includes a grouping module 325 that retrieves targeting criteria from ad objects and identifies users having one or more characteristics specified by the targeting criteria. The grouping module 325 accesses information about users from the user profile store 305, the edge store 315 and/or the action log 335 to identify users satisfying one or more targeting criteria. In one embodiment, the grouping module 325 associates groups of users with targeting criteria satisfied by users in a group. Hence, a group of user profiles generated by the grouping module includes users that having a common characteristic satisfying targeting criteria associated with the group.

The grouping module 325 may associate one or more advertisements with a group of users to expedite identification of users satisfying targeting criteria associated with the advertisement. Targeting criteria associated with advertisements identifies any edge, action, characteristic or other characteristic for identifying to received the advertisement. For example, the social networking system 104 receives targeting criteria from an advertiser to target one or more advertisements to users that have previously checked-in to a specified location. In some embodiments, targeting criteria associated with an advertisement may not necessarily include objects. For example, to advertise for a local marathon, an advertisement may include targeting criteria to identify users that have previously run. From the targeting criteria and accessed information, the grouping module 325 identifies groups of users having the characteristics specified by the targeting criteria (e.g., having performed the check-in action to the specified location). User identifiers associated with users satisfying the targeting criteria are included in the group of users, which may be associated with the targeting criteria or with the advertisement.

The action logger 330 receives communications about user actions on and/or off the social networking system 104, and populates the action log 335 with information about user actions. Such actions may include, for example, adding a connection to another user, sending a message to another user, uploading an image, reading a message from another user, viewing content associated with another user, attending an event posted by another user, among others. In addition, a number of actions described in connection with other objects are directed toward particular users, so these actions are associated with those users as well. These actions are stored in the action log 335.

Users may interact with various objects on the social networking system 104, including commenting on posts, sharing links, and checking-in to physical locations via requesting device 102, accessing content items in a sequence, or other interactions. Information describing these actions is captured by the action logger 330 and stored in the action log 335. Additional examples of interactions with objects on the social networking system 104 included in the action log 335 include commenting on a photo album, enabling communications between users, becoming a fan of a musician, adding an event to a calendar, joining a group, becoming a fan of a brand page, creating an event, authorizing an application, using an application, and engaging in a transaction. Additionally, the action log 335 records a user's interactions with advertisements on the social networking system 104 as well as other applications operating on the social networking system 104.

The action log 335 may also store user actions taken on external websites. For example, an e-commerce website that primarily sells sporting equipment at bargain prices may recognize a user of a social networking system 104 through social plug-ins that enable the e-commerce website to identify the user of the social networking system 104. Because users of the social networking system 104 are uniquely identifiable, e-commerce websites, such as this sporting equipment retailer, may use the information about these users as they visit their websites. The action log 335 records data about these users, including webpage viewing histories, advertisements that were engaged, purchases made, and other patterns from shopping and buying.

The authorization server 337 enforces one or more privacy settings of the users of the social networking system 104. A privacy setting of a user determines how particular information associated with a user can be shared. The privacy setting comprises a specification of particular information associated with a user and a specification of the entity or entities with which the information can be shared. Examples of entities with which information can be shared may include other users, applications, advertisers 106, or any entity that can potentially access the information. The information that may be shared by a user comprises, for example, user profile information like profile photo, phone numbers associated with the user, user's connections, actions taken by the user such as adding a connection, changing user profile information the like.

The selection module 340 selects one or more candidate ad objects from the advertisement store 320 from which an ad object is identified for presentation to a user. The selection module 340 may compare user profile information for a user identified by an ad request to targeting criteria associated with ad objects and selects candidate ad objects having one or more targeting criteria satisfied by the user profile information. In one embodiment, the selection module 340 accesses the advertisement store 320 and/or the grouping module 325 to identify candidate ad objects. Alternatively, the selection module 340 receives advertisement requests including a user identifier and identifies candidate advertisements from the advertisement store 320 associated with targeting criteria satisfied by the user.

In one embodiment, the selection module 340 ranks the candidate ad objects based on the bid prices associated with the candidate ad objects. For example, the selection module 340 performs an auction using the candidate ad objects to select an ad object. The selection module 340 calculates an expected value for each of the candidate ad objects. An expected value of a candidate ad object is based on its associated bid price and the likelihood of the identified user accessing an advertisement associated with the candidate ad object. In some embodiments, the selection module 340 uses the bid price of a candidate ad object as its expected value. As described above in conjunction with FIG. 1, the selection module 340 may apply a use fee to the bid price of a candidate ad object to determine an adjusted bid price for the candidate ad object, which is used to determine the expected value of the candidate ad object. Based on the expected values of the candidate ad objects, the selection module 340 ranks the candidate ad objects and uses the ranking to select a candidate ad object (e.g., select the advertisement with the highest ranking).

If an advertisement request includes one or more request parameters, the selection module 340 filters the candidate ad objects using the request parameters before ranking the candidate advertisements. Examples of criteria specified by request parameters include: a specified size of the advertisement in a candidate ad object, a threshold number of times an advertisement in a candidate ad object has been provided to the requesting device 102 by the social networking system 104, a threshold expected value associated with advertisement candidate ad object, content of the advertisement in a candidate ad object, that the advertisement in an candidate ad object has not been previously presented to the requesting device 102 or some combination thereof.

If the user identified by the user ID information satisfies targeting criteria for multiple candidate ad objects, selection module 340 may select specific targeting criteria and rank the candidate ad objects associated with the selected targeting criteria. Selection module 340 may select the targeting criteria based on characteristics of advertisements associated with the targeting criteria. For example, targeting criteria of ad objects having the highest average expected value, of ad objects including advertisements having the highest or lowest frequency of display, of ad objects including advertisements having content for which the user has a threshold affinity, or any other suitable characteristics may be selected. In other embodiments, the selection module 340 may select an ad objects without filtering or limiting the candidate ad objects from which the ad object is selected.

The selection module 340 communicates a description of the selected ad object to the communications module 355, which communicates the description to the external system 108. Using the description and information associated with additional advertisements by the external system 108, the external system 108 selects an advertisement from additional advertisements maintained by the external system 108. For example, the external system 108 conducts an auction based on the additional advertisements and the description; hence, the external system 108 uses information external to the social networking system 104 to select an advertisement. In an embodiment, the external system 108 selects an alternative advertisement or the description of the selected ad object associated with the highest bid price. If the selected ad object is associated with the highest bid price, the external system 108 determines an external clearing price for the selected ad object and provides the external clearing price to the social networking system 104 via the network 220, as described above in conjunction with FIG. 1. The selection module 340 adjusts the external clearing price to include a transaction fee assessed by the external system 108 for selecting an advertisement. The transaction fee is further described above in conjunction with FIG. 1.

In an alternative embodiment, the external system 108 transmits a description of the advertisement it selects to the selection module 340, which determines whether the selected ad object or the advertisement selected by the external system 108 is presented. For example, the selected ad object is presented if the adjusted internal bid price is higher than the bid prices of the additional advertisements maintained by the external system 108. As an example, if the adjusted internal bid price is $0.90 and the highest bid price associated with an advertisement maintained by the external system 108 is $0.95, the external advertisement associated with the $0.95 bid price is served by the external system 108. In contrast, if the adjusted internal bid price of $0.90 and the highest bid price associated with an external advertisement maintained by the external system 108 is $0.60 the selection module 340 selects the selected candidate ad object for presentation.

If the selected candidate ad object is selected for presenting to a user, the fee module 345 determines a fee for serving the advertisement associated with the candidate ad object to the user based on the internal clearing price and the adjusted external clearing price. As discussed in above in conjunction with FIG. 1, if an advertisement maintained by the external system 108 has a higher bid price than the adjusted internal bid price of the selected candidate ad object, the candidate ad object is not served by the social networking system 104 and no fee is charged. However, if the adjusted external clearing price is less than the internal clearing price, the social networking system 104 determines 170 the fee is the internal clearing price. If the adjusted external clearing price is greater than the internal clearing price, the social networking system 104 determines 170 the fee is the adjusted external clearing price. In general, if the internal bid price is greater than the external bid price, the fee module 345 determines the fee as the larger of the internal clearing price (including use fee) and the adjusted external clearing price (including transaction fee).

The fee module 345 charges the determined fee to the advertiser associated with the selected candidate ad object. In some embodiments, the social networking system 104 has to pay one or more parties (e.g., the external system 108) when presenting an advertisement, so the amount netted by the social networking system 104 from the charged fee may vary. For example, if the external system 108 serves an advertisement rather than the social networking system 104, no fee is netted. If the internal clearing price exceeds the adjusted external clearing price, the social networking system 104 charges the internal clearing price and nets the difference between the internal clearing price and the adjusted external clearing price. If the adjusted external clearing price exceeds the internal clearing price, the social networking system 104 nets the difference between the adjusted external clearing price and the external clearing price, which is the transaction fee.

The social context module 350 identifies social context information associated with a user identified by the user ID information. In one embodiment, social context module 350 retrieves data from the user profile store 305 to determine if a user associated with the user ID information is currently logged into the social networking system 104. If the user is logged in, the social context module 350 identifies users connected to the user from the user profile store 305 and/or the edge store 310 and identifies actions or characteristics of the users connected to the user from the user profile store 305 or from the action log 335. The social context module 350 selects actions or characteristics of the users connected to the user based on the content of the selected advertisement and presents the selected actions or characteristics to the user along with the selected advertisement. FIG. 1 includes social context information (“Sarah likes Tide”) embedded in the selected advertisement.

The communications module 355 is configured to transmit and receive data, via network 220, from social networking system 104 to requesting device 102, advertisers 106, external system 108, or some combination thereof. The communications module 355 receives advertisement requests from one or more requesting devices 102 and communicates information from the advertisement requests to components of the social networking system 104. Additionally, the communications module 355 sends, via the network 220, description information associated with a selected candidate ad object to the external system 108 and receives, via the network 220, a description of an external clearing price for an advertisement from the external system 108. Additionally, communications module 355 sends an advertisement selected by the social networking system 104, which may include social context information, to the requesting device 102 via the network 220.

### Selection of Advertisements for Requesting Device Users

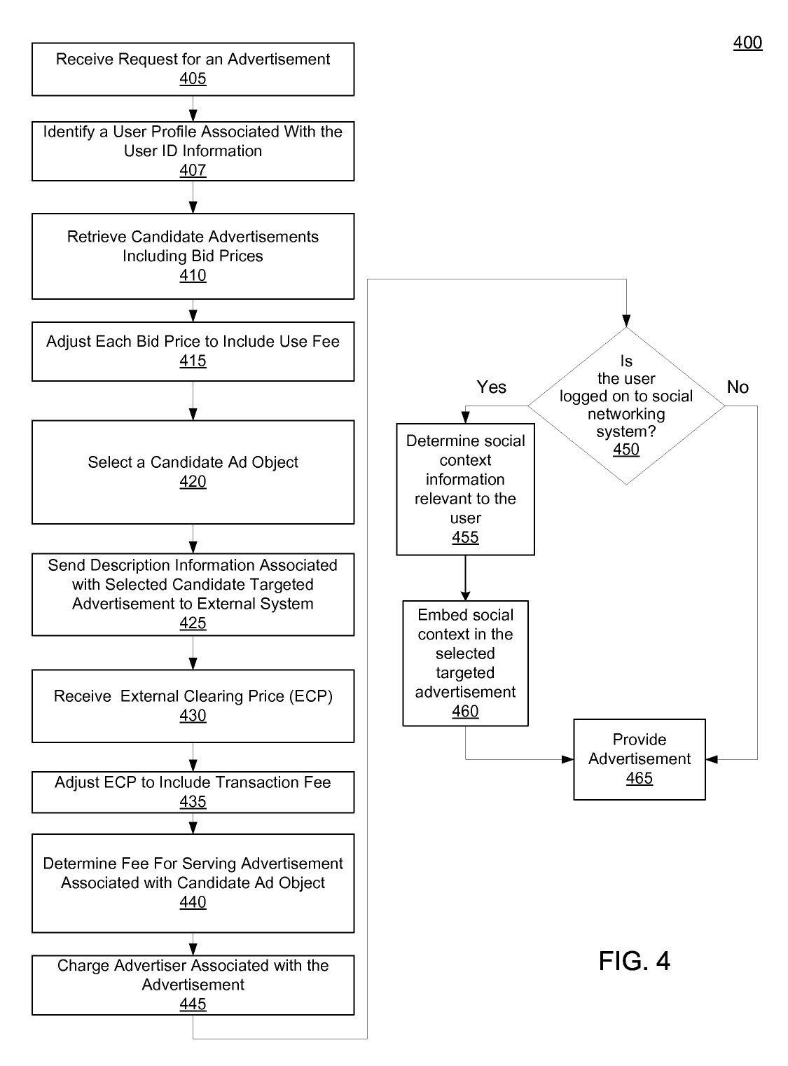

FIG. 4 illustrates a flowchart of one embodiment of a process 400 for pricing and presenting an advertisement to a social networking system user. The social networking system 104 receives 405 an advertisement request from a requesting device 102 associated with the social networking system user. The advertisement request includes user ID information associated with the social networking system user and may include one or more request parameters, as described above.

Based on the user ID information, the social networking system 104 identifies 407 a user profile. For example, the social networking system 104 identifies 407 a user profile associated with a user identifier included in the user ID information. Information from the identified user profile is compared to targeting criteria associated with ad objects stored in an advertisement store 320 of the social networking system 104 to retrieve 410 candidate ad objects, each including bid prices. As discussed above, the advertisement request may contain one or more request parameters, which may be used to filter the retrieved candidate ad objects.

The bid prices of each candidate ad object are adjusted 415 to include a use fee. For example, each bid price may be reduced by 10%. As described above, the use fee is an amount charged by the social networking system 104 to access information associated with users stored by the social networking system 104. Using the adjusted bid prices, the social networking system 104 selects 420 a candidate ad object. For example, an expected value for each of the candidate ad objects is determined from the adjusted bid prices and the likelihood of the user accessing an advertisement associated with a candidate ad object. To estimate the likelihood that a user will click on a candidate advertisement, the social networking system 104 may use the user's affinities for targeting criteria associated with the candidate advertisements or with other objects associated with the candidate advertisements. The candidate ad objects are ranked based on their expected values adjusted bid prices, and a candidate ad object is selected 420 based on the ranking. For example, the candidate ad object having the highest expected value is selected 420.

Data about advertisers associated with the candidate ad objects may also be used when computing the expected value of the candidate ad objects. For example, the number of users targeted by the advertiser may affect the bid price, allowing a candidate ad object from an advertiser having a lower bid price but potentially accessible to a larger group of users to have a higher expected value than candidate ad object from an advertiser having a higher bid price but potentially accessible to a smaller group of users. Alternatively, the expected value is weighted by the number of targeting criteria associated with an ad object that a user satisfies, so that candidate ad objects having more targeting criteria satisfied by the user have a higher expected value. For example, if the targeting criteria specifies 8 characteristics and a user profile satisfies 4 of the characteristics, the expected value may be weighted by the ratio of the number of characteristics satisfied to the total number of characteristics, or 0.5 in this example. In other embodiments, different functions of the targeting criteria and user profile may be used to weight the expected value.

The social networking system 104 determines an internal clearing price for the selected candidate ad object. For example, the internal clearing price is set as the adjusted bid price of the candidate ad object having the second highest adjusted bid price. Alternatively, the internal clearing price for the selected candidate object is set as the second highest adjusted bid price incremented by a specified value (e.g., 1 cent).

The social networking system 104 sends 425 a description of the selected candidate ad object to an external system 108 via the network 220. The external system 108 selects an advertisement from additional advertisements maintained by the external system 108 and from the description. For example, the external system 108 conducts an external auction based on a bid price for the selected candidate ad object form the description and bid prices for additional advertisements associated with the external system 108. The external system 108 may select one of the additional advertisements having a higher bid price than the adjusted internal bid price in the description from the external auction. As described above in conjunction with FIG. 1, the external system 108 may present the additional advertisement having the higher bid price, so the social networking system 104 does not present the selected candidate ad object.

If the external system 108 selects the selected candidate ad object (e.g., the bid price in the description of the selected candidate ad object is higher than bid prices associated with additional advertisements), the external system 108 provides the social networking system 104 with an external clearing price of the selected candidate ad object, as described above in conjunction with FIG. 1. The social networking system 104 adjusts 435 the external clearing price from the description to include a transaction fee. As discussed above, the transaction fee is assessed by the external system 108 for selecting from advertisements maintained by the external system 108. Based on the adjusted external clearing price and the internal clearing price, the social networking system 104 determines 440 a fee for serving an advertisement associated with the selected candidate ad object. For example, the social networking system 104 determines 440 the fee to be the larger of the internal clearing price, which includes the use fee, and the adjusted external clearing price, which includes the transaction fee. If the external system 108 selects and provides an alternative advertisement, the social networking system 104 determines 440 that no fee is assessed.

In one embodiment, the social networking system 104 determines 450 if the user is logged on to the social networking system 104. If the user is not logged onto the social networking system 104, the selected advertisement is provided 465 to the requesting device 102. However, if the user is logged into the social networking system 104, the social networking system 104 determines 455 social context information associated with the user. For example, the social networking system 104 determines actions taken by other users of the social networking system 104 connected to the identified user and that are associated with content related to or identified by the selected advertisement. In one embodiment, the social context is embedded 460 in the advertisement from the selected candidate ad object, and the social context along with the advertisement is provided 465 to the requesting device 102. Alternatively, the social context may be presented in conjunction with the selected advertisement in any suitable manner via the requesting device 102. In one embodiment, the social networking system 104 charges the advertiser associated with the selected advertisement an additional fee if social context information is presented along with the selected advertisement.

### SUMMARY

The foregoing description of the embodiments has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A method comprising:
receiving a request for an advertisement, the request including user identification information associated with a user of a social networking system;
retrieving a plurality of candidate advertisements associated with a bid price and targeting criteria specifying one or more characteristics of the user stored by the social networking system in a user profile for the user;
adjusting the bid price of each of the plurality of candidate advertisements to include a fee for using the information associated with the user by the social network system;
selecting a candidate advertisement from the plurality of candidate advertisements based on the adjusted bid prices;
determining an internal clearing price associated with the selected candidate advertisement;
sending a description of the selected candidate advertisement to an external system including additional advertisements each associated with a bid price, the description including the adjusted bid price associated with the selected candidate advertisement;
receiving an external clearing price associated with the selected candidate advertisement from an external system; and
determining a fee for serving the selected candidate advertisement.

2. The method of claim 1, further comprising:
adjusting the external clearing price to include a transaction fee, and
wherein the fee for serving the selected candidate advertisement comprises the larger of the internal clearing price and the adjusted external clearing price.

3. The method of claim 1, wherein selecting the candidate advertisement from the plurality of candidate advertisements based on the adjusted bid prices comprises:
computing an expected value for each of the candidate advertisements based on an adjusted bid price associated with a candidate advertisement and a likelihood that the user accesses the candidate advertisement;
ranking the candidate advertisements based on the expected values; and
selecting the candidate advertisement based on the ranking.

4. The method of claim 3, wherein computing an expected value of the candidate advertisement comprises multiplying the adjusted bid price associated with the candidate advertisement by the likelihood that the user accesses the candidate advertisement.

5. The method of claim 3, wherein selecting the candidate advertisement based on the ranking comprises:
selecting a candidate advertisement having a highest expected value.

6. The method of claim 5, wherein the internal clearing price of the selected candidate advertisement is an adjusted bid amount associated with a candidate advertisement having a second highest expected value.

7. The method of claim 5, wherein the internal clearing price of the selected candidate advertisement is an adjusted bid amount associated with a candidate advertisement having a second highest expected value incremented by a specified value.

8. The method of claim 1, further comprising presenting the selected candidate advertisement to the user via the requesting device.

9. The method of claim 8, wherein presenting the selected candidate advertisement to the user via the requesting device includes:
identifying one or more additional users connected to the user of the social networking system from the information associated with the user by the social networking system;
retrieving social context information describing an action between an additional user connected to the user of the social networking system and data associated with the selected advertisement;
modifying the selected advertisement to include the social context information; and
presenting the modified selected advertisement to the user via the requesting device.

10. The method of claim 9, further comprising:
charging the advertiser associated with the selected advertisement an additional fee for modifying the selected advertisement to include the social context information.

11. The method of claim 8, wherein the requesting device is a mobile device.

12. The method of claim 1, wherein the request for the advertisement includes a request parameter specifying one or more characteristics of an advertisement.

13. The method of claim 1, wherein the one or more characteristics of the advertisement are selected from a group consisting of: an indication the advertisement has not been previously provided to the requesting device, a threshold size of the advertisement, a time interval, a limit on a number of times the advertisement was previously presented to the requesting device, a maximum adjusted clearing price of the advertisement, content associated with the advertisement, and any combination thereof.

14. The method of claim 1, further comprising:
charging an advertiser associated with the selected candidate advertisement the determined fee.

15. A method comprising:
receiving a request for an advertisement including user identification information associated with a user of a social networking system;
retrieving a plurality of candidate ad objects each having a bid price and having one or more targeting criteria satisfied by information associated with the user by the social networking system, each ad object also including an advertisement;
selecting a candidate ad object from the plurality of candidate ad objects based on the bid prices of the candidate ad objects;
determining an internal clearing price for the selected candidate ad object;
sending a description of the selected candidate ad object including the bid price associated with the selected candidate ad object to an external system;
receiving an external clearing price from the external system if the external system selects the selected candidate ad object based on the bid price associated with the selected candidate ad object and bid prices associated with additional advertisements maintained by the external system;
determining a fee for serving an advertisement associated with the selected candidate ad object; and
charging an advertiser associated with the selected candidate ad object the determined fee.

16. The method of claim 15, further comprising:
presenting the advertisement associated with the selected candidate ad object to the user via the requesting device.

17. The method of claim 16, wherein the requesting device is a mobile device.

18. The method of claim 16, wherein presenting the advertisement associated with the selected candidate ad object to the user via the requesting device comprises:
identifying one or more additional users connected to the user of the social networking system from the information associated with the user by the social networking system;
retrieving social context information describing an action between an additional user connected to the user of the social networking system and data associated with the selection; and
presenting the social context information to the user along with the advertisement.

19. The method of claim 15, wherein selecting the candidate ad object from the plurality of candidate ad objects based on the bid prices of the candidate ad objects comprises:
computing an expected value for each of the candidate ad objects based on an bid price associated with a candidate ad object and a likelihood that the user accesses an advertisement included in the candidate ad object;
ranking the candidate ad objects based on the expected values; and
selecting the candidate ad object based on the ranking.

20. The method of claim 19, wherein computing the expected value of the candidate ad object comprises multiplying the bid price associated with the candidate ad object by the likelihood that the user accesses the advertisement included in the candidate ad object.

21. The method of claim 19, wherein selecting the candidate ad object based on the ranking comprises:
selecting a candidate ad object having a highest expected value.

22. The method of claim 21, wherein the internal clearing price of the selected candidate ad object comprises a bid amount associated with a candidate ad object having a second highest expected value.

23. The method of claim 15, further comprising:
adjusting the external clearing price to include a transaction fee, and
wherein the fee for serving the selected candidate advertisement comprises the larger of the internal clearing price and the adjusted external clearing price.

24. A method comprising:
identifying a user of a social networking system to provide with advertising;
retrieving a plurality of candidate advertisements associated with a bid price and one or more targeting criteria satisfied by information in a user profile associated with the user by the social networking system;
selecting a candidate advertisement from the plurality of candidate advertisements based on the bid prices, the selected candidate advertisement associated with an internal clearing price;
sending a description of the selected candidate advertisement including the internal clearing price to an external system;
receiving an external clearing price associated with the selected candidate advertisement by the external system;
adjusting the external clearing price to include a transaction fee;
determining a fee for serving the selected candidate advertisement, the fee comprising the larger of the internal clearing price and the adjusted external clearing price; and
sending the selected candidate advertisement for display to the user.
